(19) United States
(12) Patent Application Publication
(10) Pub. No.: US 2023/0010031 A1
(43) Pub. Date: Jan. 12, 2023

(54) METHOD FOR RECOGNIZING TEXT, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Pengyuan LYU, Beijing (CN); Sen FAN, Beijing (CN); Xiaoyan WANG, Beijing (CN); Yuechen YU, Beijing (CN); Chengquan ZHANG, Beijing (CN); Kun YAO, Beijing (CN); Junyu HAN, Beijing (CN)

(21) Appl. No.: 17/946,464

(22) Filed: Sep. 16, 2022

(30) Foreign Application Priority Data
Jan. 6, 2022 (CN) 202210013631.1

(51) Int. Cl. G06V 10/77; G06V 20/62; G06V 10/74

(52) U.S. Cl. CPC G06V 10/7715; G06V 20/62; G06V 10/761

(57) ABSTRACT

A method for recognizing a text, an electronic device and a storage medium. An implementation of the method comprises: obtaining a multi-dimensional first feature map of a to-be-recognized image; performing, based on feature values in the first feature map, feature enhancement processing on each feature value in the first feature map; and performing a text recognition on the to-be-recognized image based on the first feature map after the enhancement processing.

### CROSS-REFERENCE TO RELATED APPLICATIONS

This application claims priority to Chinese Patent Application No. 202210013631.1, filed with the China National Intellectual Property Administration (CNIPA) on Jan. 6, 2022, the content of which is incorporated herein by reference in its entirety.

### TECHNICAL FIELD

The present disclosure relates to the field of artificial intelligence technology, and more specifically, to the fields of deep learning and computer vision technologies.

### BACKGROUND

In many fields, such as education, medical care, and finance, texts are sometimes embedded in images. In order to accurately process information based on these images, it is necessary to perform text recognition on these images, and then perform information processing based on the text recognition result.

### SUMMARY

Embodiments of the present disclosure provides a method for recognizing a text, a device and a storage medium.

In a first aspect, some embodiments of the present disclosure provide a method for recognizing a text, the method includes: obtaining a multi-dimensional first feature map of a to-be-recognized image; performing, based on feature values in the first feature map, feature enhancement processing on each feature value in the first feature map; and performing a text recognition on the to-be-recognized image based on the first feature map after the enhancement processing.

In another aspect of the present discourse, some embodiments of the present disclosure provide an electronic device, the electronic device includes: at least one processor; a storage device, in communication with the at least one processor, where the storage device stores instructions which, when executed by the at least one processor, enable the at least one processor to perform the method for recognizing a text according to any one of the implementations described in the first aspect.

In another aspect of the present discourse, some embodiments of the present disclosure provide a non-transitory computer readable storage medium, storing computer instructions which, when executed by a computer, cause the computer to perform the method for recognizing a text according to any one of the implementations described in the first aspect.

It should be understood that the content described in this part is not intended to identify key or important features of embodiments of the present disclosure, and is not used to limit the scope of the present disclosure. Other features of the present disclosure will be easily understood through the following description.

### BRIEF DESCRIPTION OF THE DRAWINGS

The accompanying drawings are used for a better understanding of the scheme, and do not constitute a limitation to the present disclosure. Here:

FIG. 1 is a schematic flow diagram of a first method for recognizing a text provided in an embodiment of the present disclosure;

FIG. 2 is a schematic flow diagram of a second method for recognizing a text provided in an embodiment of the present disclosure;

FIG. 3 is a schematic flow diagram of a third method for recognizing a text provided in an embodiment of the present disclosure;

FIG. 4 is a schematic flow diagram of a fourth method for recognizing a text provided in an embodiment of the present disclosure;

FIG. 5 is a schematic flow diagram of a fifth method for recognizing a text provided in an embodiment of the present disclosure;

FIG. 6 is a schematic structural diagram of a first apparatus for recognizing a text provided in an embodiment of the present disclosure;

FIG. 7 is a schematic structural diagram of a second apparatus for recognizing a text provided in an embodiment of the present disclosure;

FIG. 8 is a schematic structural diagram of a third apparatus for recognizing a text provided in an embodiment of the present disclosure;

FIG. 9 is a schematic structural diagram of a fourth apparatus for recognizing a text provided in an embodiment of the present disclosure;

FIG. 10 is a schematic structural diagram of a fifth apparatus for recognizing a text provided in an embodiment of the present disclosure; and

FIG. 11 is a block diagram of an electronic device used to implement the method for recognizing a text according to the embodiments of the present disclosure.

### DETAILED DESCRIPTION OF EMBODIMENTS

Exemplary embodiments of the present disclosure are described below in combination with the accompanying drawings, and various details of embodiments of the present disclosure are included in the description to facilitate understanding, and should be considered as exemplary only. Accordingly, it should be recognized by one of ordinary skill in the art that various changes and modifications may be made to the embodiments described herein without departing from the scope of the present disclosure. Also, for clarity and conciseness, descriptions for well-known functions and structures are omitted in the following description.

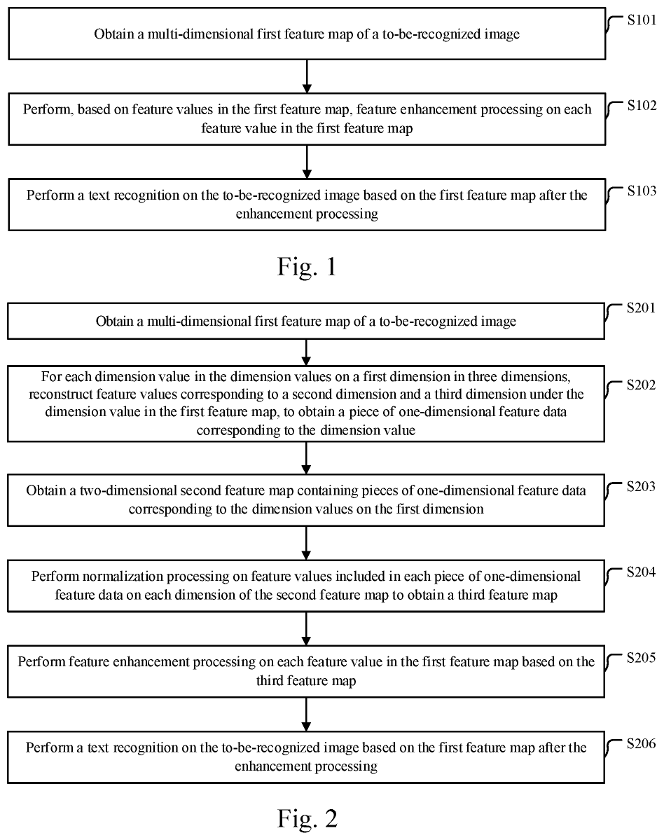

Referring to FIG. 1, FIG. 1 is a schematic flow diagram of a first method for recognizing a text provided in an embodiment of the present disclosure. The above method includes the following steps S101-S103:

Step S101, obtaining a multi-dimensional first feature map of a to-be-recognized image.

The above first feature map is a map containing feature values on a plurality of dimensions of the to-be-recognized image. The dimensions of the first feature map depend on a specific scenario. For example, the above first feature map may be a three-dimensional feature map. In this case, three dimensions of the first feature map may be a width dimension, a height dimension, and a depth dimension, respectively. Here, the dimension values on the depth dimension may be determined by the number of channels of the to-be-recognized image. For example, if the to-be-recognized image is an image in an RGB format, the to-be-recognized image has three channels, namely, an R channel, a G channel and a B channel, then the dimension values of the to-be-recognized image on the depth dimension are respectively 1, 2 and 3.

The first feature map may be obtained through the following two different implementations.

In one implementation, a to-be-recognized image may be first obtained, and then feature extraction may be performed on the to-be-recognized image to obtain the above first feature map.

In another implementation, feature extraction may be performed on a to-be-recognized image through another device which has a feature extraction function, and then a feature map obtained by the device by performing the feature extraction on the to-be-recognized image may be acquired as the first feature map.

The feature extraction performed on the to-be-recognized image may be implemented based on a feature extraction network model or a feature extraction algorithm in the prior art. For example, the above feature extraction network model may be a convolutional neural network model, for example, may be a vgg network model, a renset network model, and a mobile net network model in convolutional neural networks. The above feature extraction model may alternatively be a network model such as an FPN (Feature Pyramid Network), a PAN (Pixel Aggregation Network), etc., and the above feature extraction algorithm may be an operator such as deformconv, se, dilationconv, or inception.

Step S102, performing, based on feature values in the first feature map, feature enhancement processing on each feature value in the first feature map.

An image feature has a receptive field in an image, and the above receptive field may be understood as a source of the image feature. The above receptive field may be a partial region of the image, and the image feature is representative of the partial region. The receptive fields of different image features may be different. When the receptive field of the image feature changes, the image feature also changes. By performing the feature enhancement processing on the each feature value in the first feature map, the receptive field of the each feature value in the first feature map can be enlarged, thereby improving the representativeness of the first feature map to the to-be-recognized image.

Since the feature values in the first feature map are taken into consideration when the feature enhancement processing is performed on each feature value in the first feature map, it can be considered that the feature enhancement processing is implemented based on a global attention mechanism.

For detailed implementations of the feature enhancement processing on each feature value in the first feature map, reference may be made to the steps S202-S205 in the subsequent embodiment shown in FIG. 2 and the steps S502-S504 in the subsequent embodiment shown in FIG. 5, and thus, the details will not be repeated herein.

Step S103, performing a text recognition on the to-be-recognized image based on the first feature map after the enhancement processing.

In an implementation, after the first feature map after the enhancement processing is obtained, a textbox in the to-be-recognized image may be predicted based on the feature map, and then the text recognition is performed on the content in the textbox to obtain the text contained in the to-be-recognized image.

Particularly, the text recognition may be implemented through various existing decoding techniques, and thus will not be described in detail here.

It can be seen from the above that, when the scheme provided by the embodiment of the present disclosure is applied to perform the text recognition, the multi-dimensional first feature map of the to-be-recognized image is first obtained, the feature enhancement processing is then performed on each feature value in the first feature map based on the feature values in the first feature map, and the text recognition is performed based on the first feature map after the enhancement processing, and thus, the text recognition performed on the to-be-recognized image can be implemented.

In addition, during the feature enhancement processing on each feature value in the first feature map, the processing is performed on each feature value based on the feature values in the first feature map. Accordingly, each feature value in the first feature map after the enhancement processing takes the global information of the image into consideration. Therefore, the first feature map after the enhancement processing is capable of representing the global information of the to-be-recognized image, and thus, by performing the text recognition on the to-be-recognized image based on the first feature map after the enhancement processing, the accuracy of the text recognition can be improved.

The detailed presentation forms of a first dimension, a second dimension and a third dimension in the above embodiment are described below.

In an embodiment of the present disclosure, the first dimension is a depth dimension, the second dimension is a width dimension, and the third dimension is a height dimension.

The following two situations may exist when the feature extraction is performed on the to-be-recognized image.

In one situation, when the to-be-recognized image is a multi-channel image of a format such as RGB, feature extraction may be performed on the image of each channel respectively during the feature extraction on the to-be-recognized image, and accordingly, the obtained feature map is a three-dimensional feature map formed by a plurality of two-dimensional feature maps. In this case, the depth dimension corresponds to the channels of the image, and the maximum dimension value in the dimension values on the depth dimension is the number of the channels of the image.

In the other situation, a plurality of feature extractions may be performed on the to-be-recognized image in order to obtain a feature map with strong representativeness. One two-dimensional feature map can be obtained for each feature extraction, and a plurality of feature maps can be obtained for the plurality of feature extractions. The plurality of feature maps can form a three-dimensional feature map. In this case, the depth dimension corresponds to the number of the feature extractions on the image, and the maximum dimension value in the dimension values on the depth dimension is the number of the feature extractions on the image.

Based on the above two situations, in the situation where the first dimension is the depth dimension, the second dimension is the width dimension, and the third dimension is the height dimension, the feature values corresponding to the second dimension and the third dimension under each dimension value on the first dimension in the first feature map are capable of forming a two-dimensional feature map according to the height dimension and the width dimension. Accordingly, a reconstruction on the feature values corresponding to the second dimension and the third dimension is equivalent to a reconstruction on the feature values in the two-dimensional feature map. A reconstruction on the feature values in a single two-dimensional feature map can avoid interference caused by other two-dimensional feature maps, thereby facilitating the acquisition of the above one-dimensional feature data.

The feature enhancement processing performed on the each feature value in the first feature map in step S102 is described below.

In an embodiment of the present disclosure, referring to FIG. 2, a schematic flow diagram of a second method for recognizing a text is provided. The above first feature map is a three-dimensional feature map. The above method for recognizing a text includes the following steps S201-S206:

Step S201, obtaining a multi-dimensional first feature map of a to-be-recognized image.

The above step S201 is the same as the foregoing step S101, and thus will not be repeatedly described here.

Step S202, for each dimension value in the dimension values on a first dimension in three dimensions, reconstructing feature values corresponding to a second dimension and a third dimension under the dimension value in the first feature map, to obtain one-dimensional feature data corresponding to the dimension value.

In an implementation, the above three dimensions of the first feature map may be a depth dimension, a width dimension, and a height dimension.

For example, the above first feature map may be expressed as a feature map of C*H*W. Here, C expresses the depth dimension of the first feature map, and the dimension value on the dimension may be from 1 to the number of the channels of the to-be-recognized image. H expresses the height dimension of the first feature map, and the dimension value on the dimension may be from 1 to the maximum number of the pixels in a column of the first feature map. W expresses the width dimension of the first feature map, and the dimension value on the dimension may be from 1 to the maximum number of the pixels in a row of the first feature map.

Taking the height dimension H of the first feature map as an example, if the maximum number of the pixels in the column of the first feature map is 20, the dimension values on the height dimension of the first feature map may be 1, 2, 3, 4 . . . 18, 19 and 20.

Each feature value in the first feature map has a corresponding dimension value on each of the three dimensions.

For example, the coordinates of one feature value on the three dimensions are (c1, h1, w1), indicating that the feature value has a dimension value c1 on the depth dimension of the first feature map, a dimension value h1 on the height dimension, and a dimension value w1 on the width dimension.

For each dimension value (the dimension value is denoted as V for the convenience of expression) in the dimension values on the first dimension, the feature values corresponding to the second dimension and the third dimension under the dimension value V indicate respective feature values whose dimension values on the first dimension are the dimension value V in the feature values contained in the first feature map.

Particularly, under each dimension value on the first dimension, the feature values corresponding to the second and third dimensions belong to two-dimensional data, and the two-dimensional data forms a two-dimensional feature map. Therefore, for each dimension value on the first dimension, the feature values corresponding to the second and third dimensions under the dimension value can be understood as: feature values contained in a two-dimensional feature map under the dimension value on the first dimension. Based on this, reconstructing the corresponding feature values to obtain the one-dimensional feature data may be understood as: performing a dimensional transformation on the two-dimensional feature map to obtain the one-dimensional feature data, the one-dimensional feature data containing each feature value in the two-dimensional feature map.

For example, the feature values in the two-dimensional feature map may be transformed into the one-dimensional feature data by concatenating the feature values in the two-dimensional feature map head to tail by row, but the feature values in the two-dimensional feature map may also be transformed into the one-dimensional feature data by concatenating the feature values in the two-dimensional feature map head to tail by column, which is not limited in embodiments of the present disclosure.

Step S203, obtaining a two-dimensional second feature map containing pieces of one-dimensional feature data corresponding to the dimension values on the first dimension.

The above second feature image is a two-dimensional image, having two dimensions. Here, one dimension (for the convenience of expression, this dimension may be referred to as dimension X) corresponds to the first dimension, and the dimension value of the dimension is the same as that of the first dimension. The other dimension (for the convenience of expression, this dimension may be referred to as dimension Y) corresponds to the second and third dimensions, and the dimension values on the dimension Y are values from 1 to the combined dimension value, the combined dimension value being equal to the product of the maximum dimension value on the second dimension and the maximum dimension value of the third dimension.

For example, the above dimension X may correspond to a pixel row dimension in the second feature map, and the dimension Y may correspond to a pixel column dimension in the second feature map. In this case, when the value of X is fixed, the pixel row is fixed, and the pixel row includes a feature value corresponding to each Y value on the dimension Y. That is, each pixel row corresponds to one dimension value on the first dimension, and each pixel value in the pixel row is a feature value in the one-dimensional feature data corresponding to the dimension value corresponding to the pixel row.

In view of above, in an embodiment of the present disclosure, the pieces of one-dimensional feature data corresponding to the dimension values on the first dimension may be arranged according to the arrangement order of the dimension values on the first dimension, to form two-dimensional feature data containing the pieces of one-dimensional feature data as the two-dimensional second feature map.

Particularly, when the pieces of one-dimensional feature data are arranged, the pieces of one-dimensional feature data may be arranged in rows, or may be arranged in columns.

For example, if the dimension value 1 on the first dimension corresponds to one-dimensional feature data [m₁₁, m₁₂ . . . min], the dimension value 2 on the first dimension corresponds to one-dimensional feature data [m₂₁, m₂₂ . . . m₂ₙ], and the dimension value 3 on the first dimension corresponds to one-dimensional feature data [m₃₁, m₃₂ . . . m₃ₙ], the pieces of one-dimensional feature data are used as rows and are arranged according to the descending order of the corresponding dimension values on the first dimension, and then the data included in the second feature map is obtained as follows:

$$[ \begin{matrix}{m}_{11} & {m}_{12} & … … {m}_{1 n} \\ {m}_{21} & {m}_{22} & … … {m}_{2 n} \\ {m}_{31} & {m}_{32} & … … {m}_{3 n}\end{matrix} ] .$$

As can be seen from the above second feature map, the dimension value 1 on the dimension X corresponds to the one-dimensional feature data [m₁₁, m₁₂ . . . min], the dimension value 2 on the dimension X corresponds to the one-dimensional feature data [m₂₁, m₂₂ . . . m₂ₙ], and the dimension value 3 on the dimension X corresponds to the one-dimensional feature data [m₃₁, m₃₂ . . . m₃ₙ].

Step S204, performing normalization processing on feature values included in each piece of one-dimensional feature data on each dimension of the second feature map to obtain a third feature map.

Since the second feature map is a two-dimensional image, the second feature map may be considered as containing a plurality of pieces of one-dimensional feature data, from the perspective of one dimension. In view of this, in different dimensions, the one-dimensional feature data in the second feature map may be divided into two types of feature data.

The first type of feature data refers to the pieces of one-dimensional feature data corresponding to the each dimension value on the dimension X in the second feature map. In this case, each piece of one-dimensional feature data includes the feature values corresponding to dimension values on the dimension Y under the each dimension value on the dimension X, and the number of the included feature values is equal to the number of the dimension values on the dimension Y.

The second type of feature data refers to pieces of one-dimensional feature data corresponding to each dimension value on the dimension Y in the second feature map. In this case, each piece of one-dimensional feature data includes the feature values corresponding to dimension values on the dimension X under the each dimension value on the dimension Y, and the number of the included feature values is equal to the number of the dimension values on the dimension X.

It can be seen from the above that each piece of one-dimensional feature data in the second feature map includes a plurality of feature values. During the normalization processing, the normalization processing is performed on feature values in each piece of one-dimensional feature data with the each piece of one-dimensional feature data as a unit.

The normalization processing is described below.

In an embodiment of the present disclosure, the second feature map is a two-dimensional image and includes two dimensions, namely, the dimension X and the dimension Y. Accordingly, during the normalization processing, the normalization processing may be first performed on the feature values contained in each piece of one-dimensional feature data corresponding to one of the above two dimensions, and then, based on the obtained normalization processing result, the normalization processing may be performed on the feature values contained in each piece of one-dimensional feature data corresponding to the other dimension in the two dimensions, thus obtaining the third feature map.

In an implementation, the normalization processing may be first performed on the feature values contained in each piece of one-dimensional feature data corresponding to the dimension X, and then, based on the obtained normalization processing result, the normalization processing may be performed on the feature values contained in each piece of one-dimensional feature data corresponding to the dimension Y. That is, the normalization processing is first performed on the first type feature data, and then, based on the obtained processing result, the normalization processing is first performed on the second type feature data.

In an other implementation, the normalization processing may be first performed on the feature values contained in each piece of one-dimensional feature data corresponding to the dimension Y, and then, based on the obtained normalization processing result, the normalization processing may be performed on the feature values contained in each piece of one-dimensional feature data corresponding to the dimension X. That is, the normalization processing is first performed on the second type feature data, and then, based on the obtained processing result, the normalization processing is first performed on the first type feature data.

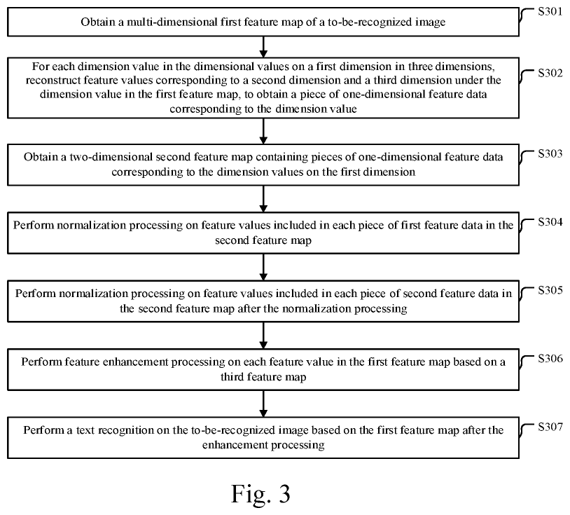

For the detailed implementation of the normalization processing, reference may be made to steps S304-S305 in the subsequent embodiment shown in FIG. 3, and thus, the details will not be repeated herein.

The normalization processing only changes the values of the feature values, but does not change the size of the image. Therefore, the third feature map obtained after the normalization processing has the same number of dimensions and size as the second feature map. If the second feature map is a feature map of C*(H*W), the third feature map is also a feature map of C*(H*W).

Step S205, performing feature enhancement processing on each feature value in the first feature map based on the third feature map.

The third feature map is a two-dimensional image and the first feature map is a three-dimensional image. For example, the third feature map may be represented as a two-dimensional image of C*(H*W), and the first feature map may be represented as a three-dimensional image of C*H*W. Thus, for the third feature map, the two dimensions of the third feature map respectively correspond to C and H*W. For the first feature map, the three dimensions of the first feature map respectively correspond to C, H and W.

Therefore, it is possible to first unify the dimensions of the two feature maps, and then perform the feature enhancement processing on the each feature value in the first feature map on the basis that the dimensions of the first feature map and the third feature map are unified.

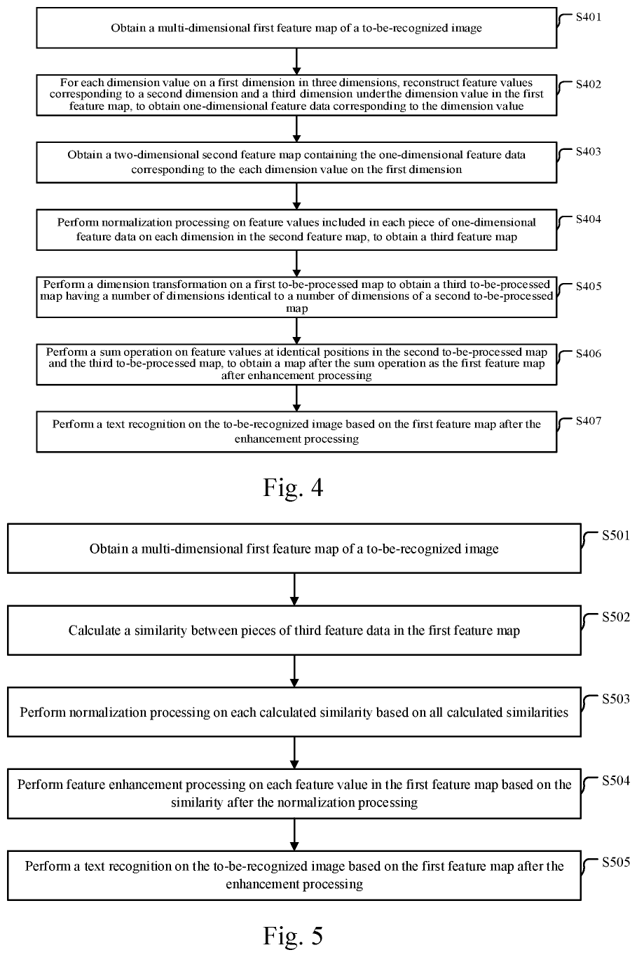

For the detailed implementation in which the dimensions of the first feature map and the third feature map are unified and the feature enhancement processing is performed on each feature value in the first feature map, reference may be made to the descriptions of steps S405-S406 in the subsequent embodiment shown in FIG. 4, and thus, the details will not be repeated herein.

Step S206, performing a text recognition on the to-be-recognized image based on the first feature map after the enhancement processing.

The above step S206 is the same as the foregoing step S103, and thus will not be repeatedly described here.

It can be seen from the above that, when the scheme provided by the embodiment of the present disclosure is applied to perform the text recognition, since the normalization processing performed on the feature values included in the one-dimensional feature data needs to be implemented using all the feature values included in the one-dimensional feature data, the each feature value in the one-dimensional feature data after the normalization processing is affected by all the feature values in the one-dimensional feature data. On this basis, the normalization processing is performed on the feature values included in the each piece of one-dimensional feature data in the each dimension in the second feature map, such that the each feature value in the third feature map is affected by all the feature values in the first feature map. Therefore, the third feature map can represent the to-be-recognized image from the perspective of a global feature. In this way, after the feature enhancement processing is performed on the each feature value in the first feature map based on the third feature map, a feature map of which the receptive field is the entire to-be-recognized image can be obtained, which enlarges the receptive field of the feature map for the text recognition, and thus, the accuracy of the text recognition on the to-be-recognized image can be improved.

The performing normalization processing on feature values included in each piece of one-dimensional feature data on each dimension in the second feature map to obtain a third feature map in step 204 is described below.

In an embodiment of the present disclosure, referring to FIG. 3, a schematic flow diagram of a third method for recognizing a text is provided. In this embodiment, the above method for recognizing a text includes the following steps S301-S307:

Step S301, obtaining a multi-dimensional first feature map of a to-be-recognized image.

Step S302, for each dimension value in the dimension values on a first dimension in three dimensions, reconstructing feature values corresponding to a second dimension and a third dimension under the each dimension value in the first feature map, to obtain a piece of one-dimensional feature data corresponding to the each dimension value.

Step S303, obtaining a two-dimensional second feature map containing pieces of one-dimensional feature data corresponding to the dimension values on the first dimension.

The above step S301 is the same as the foregoing step S101, and the above steps S302 and S303 are respectively the same as the foregoing steps S202 and S203, and thus, steps S301-S303 will not be repeatedly described here.

Step S304, performing normalization processing on feature values included in each piece of first feature data in the second feature map.

Here, the first feature data refers to the piece of one-dimensional feature data corresponding to the each dimension value on the first dimension.

As can be seen from the above description, the second feature map has two dimensions, i.e., the dimension X and the dimension Y. The dimension X corresponds to the first dimension, and the dimension Y corresponds to the second and third dimensions. In view of this, the above first feature data refers to one-dimensional feature data corresponding to each dimension value on the dimension X in the second feature map, that is, the first type of feature data mentioned in the previous step S204.

When being performed on the feature values included in the each piece of first feature data, the normalization processing is performed with the first feature data as a unit. Accordingly, for one piece of first feature data, the feature values included in the piece of first feature data are used to perform the normalization processing on the respective feature values included in the piece of first feature data.

In an embodiment of the present disclosure, the normalization processing on the feature values included in the first feature data may be implemented through a softmax algorithm. In another embodiment of the present disclosure, the normalization processing may alternatively be implemented through a normalization algorithm such as an L1 Normalize algorithm and an L2 Normalize algorithm, and thus will not be described in detail here.

Step S305, performing normalization processing on feature values included in each piece of second feature data in the second feature map after the normalization processing.

Here, the second feature data refers to a piece of one-dimensional feature data corresponding to each dimension value on a combined dimension, and the combined dimension refers to a dimension corresponding to the second and third dimensions in the second feature map. It can be seen from the above description that the above combined dimension is the dimension Y mentioned above. Accordingly, the above second feature data is one-dimensional feature data corresponding to each dimension value on the dimension Y in the second feature map, that is, the second type of feature data mentioned in the previous step S204.

When being performed on the feature values included in the each piece of second feature data, the normalization processing is performed with the second feature data as a unit. Accordingly, for one piece of second feature data, the feature values included in the second feature data is used to perform the normalization processing on the respective feature values included in the second feature data.

The normalization processing on the feature value included in the second feature data may also be implemented based on a normalization algorithm such as a softmax algorithm, an L1 Normalize algorithm and an L2 Normalize algorithm.

Step S306, performing feature enhancement processing on each feature value in the first feature map based on a third feature map.

Step S307, performing a text recognition on the to-be-recognized image based on the first feature map after the enhancement processing.

The above step S306 is the same as the foregoing step S205, and the above step S307 is the same as the foregoing step S103.

It can be seen from the above that, in the scheme provided by the embodiment of the present disclosure, when the normalization processing is performed on the feature values included in the each piece of one-dimensional feature data to obtain the third feature map, the normalization processing is first performed on the first feature data corresponding to the each dimension value on the first dimension, and then, on the basis of the normalization processing, the normalization processing is performed on the second feature data corresponding to the each dimension value on the combined dimension. The number of feature values included in the first feature data is equal to the number of dimension values on the combined dimension, and the number of the dimension values on the combined dimension is often greater than the number of dimension values on the first dimension. Therefore, by first performing the normalization processing on the first feature data, more abundant reference data can be provided for the subsequent normalization processing, which is conducive to improving the accuracy of the obtained third feature map.

In another embodiment of the present disclosure, similar to the embodiment shown in FIG. 3, after the above step S303 is performed, the above step S305 in which the normalization processing is performed on the feature values included in the each piece of second feature data may be first performed, and then, based on the normalization processing result, the step S304 in which the normalization processing is performed on the feature values included in the each piece of first feature data may be performed.

The performing feature enhancement processing on each feature value in the first feature map in step S205 is described below.

In an embodiment of the present disclosure, referring to FIG. 4, a schematic flow diagram of a fourth method for recognizing a text is provided. In this embodiment, the above method for recognizing a text includes the following steps S401-S407:

Step 401, obtaining a multi-dimensional first feature map of a to-be-recognized image.

Step S402, for each dimension value in dimension values on a first dimension in three dimensions, reconstructing feature values corresponding to the second and third dimensions under the each dimension value on the first dimension in the first feature map, to obtain a piece of one-dimensional feature data corresponding to the each dimension value.

Step S403, obtaining a two-dimensional second feature map containing pieces of one-dimensional feature data corresponding to the dimension values on the first dimension.

Step S404, performing normalization processing on feature values included in each piece of one-dimensional feature data on each dimension in the second feature map to obtain a third feature map.

The above step S401 is the same as the foregoing step S101, and the above steps S402-S404 are the same as the foregoing steps S202-S204, and thus, steps S401-S404 will not be repeatedly described herein.

Step S405, performing a dimension transformation on a first to-be-processed map to obtain a third to-be-processed map having a number of dimensions identical to a number of dimensions of a second to-be-processed map.

Here, the first to-be-processed map refers to the third feature map or the first feature map, and the second to-be-processed map refers to a feature map in the third feature map and the first feature map other than the first to-be-processed map.

In an embodiment of the present disclosure, the first to-be-processed map is the third feature map and the second to-be-processed map is the first feature map.

Since the third feature map is a two-dimensional image and the first feature map is a three-dimensional image, the two-dimensional third feature map may be transformed into a three-dimensional feature map, and the three-dimensional feature map obtained after the transformation is used as the third to-be-processed map.

The detailed implementation of transforming the third feature map into the three-dimensional feature map is described in the subsequent embodiment, and thus will not be repeated herein in detail.

In another embodiment of the present disclosure, the first to-be-processed map is the first feature map, and the second to-be-processed map is the third feature map.

In this case, the three-dimensional first feature map may be transformed into a two-dimensional feature map, and the two-dimensional feature map obtained after the transformation may be used as the third to-be-processed map.

The transformation from the three-dimensional first feature map to the two-dimensional feature map can be implemented by performing the above steps S202-S203, and therefore, the two-dimensional second feature map can be directly used as the third to-be-processed map.

Step S406, performing a sum operation on feature values at identical positions in the second and third to-be-processed maps, to obtain a feature map after the sum operation as the first feature map after enhancement processing.

Since the dimensions of the second to-be-processed map are the same as the dimensions of the third to-be-processed map, and the size of the second to-be-processed map may be the same as the size of the third to-be-processed map, a plurality of sets of two feature values which are at identical positions may be determined from the second to-be-processed map and the third to-be-processed map, and the two feature values in each set can be added together, and thus, the feature map after the sum operation can be obtained.

The following description will be respectively made in combination with the specific situations of the first to-be-processed map and the second to-be-processed map.

In situation 1, when the first to-be-processed map is the third feature map and the second to-be-processed map is the first feature map, the third to-be-processed map is a three-dimensional image, and the sum operation is performed on the feature values at the identical positions in the second to-be-processed map and the third to-be-processed map, and thus, a three-dimensional feature map after the sum operation can be obtained as the first feature map after the enhancement processing.

In situation 2, when the first to-be-processed map is the first feature map and the second to-be-processed map is the third feature map, the third to-be-processed map is a two-dimensional image, and the sum operation is performed on the feature values at the identical positions in the second to-be-processed map and the third to-be-processed map, and thus, a two-dimensional feature map after the sum operation can be obtained as the first feature map after the enhancement processing.

Step S407, performing a text recognition on the to-be-recognized image based on the first feature map after the enhancement processing.

The above step S407 is the same as the foregoing step S103, and thus will not be repeatedly described here.

It can be seen from the above that, when the scheme provided by the embodiment of the present disclosure is applied to perform the text recognition, two feature maps identical to each other in dimensions are obtained by performing the dimension transformation on one of the first feature map and the third feature map, and then the sum operation is performed on the feature values at identical positions in the two feature maps, and the image after the sum operation is used as the first feature map after the enhancement processing. The third feature map contains global image information, and thus, by performing the sum operation on the feature values at identical positions in the two feature maps having identical numbers of dimensions, the feature enhancement processing on the first feature map can be accurately implemented, thereby realizing the text recognition.

The specification of the transformation from the third feature map to the second feature map in step S405 in the embodiment shown in FIG. 4 is described below.

In an embodiment of the present disclosure, the two-dimensional third feature map may be transformed into a three-dimensional feature map through the following steps.

In a first step, one-dimensional feature data corresponding to each dimension value on the first dimension in the third feature map is reconstructed according to the dimension values on the second dimension and dimension values on the third dimension, to obtain a two-dimensional feature map corresponding to the each dimension value on the first dimension.

It can be seen from the above description of step S202 in the embodiment shown in FIG. 2 that, the feature values corresponding to the second and third dimensions under the each dimension value on the first dimension in the first feature map can be regarded as the feature values contained in a two-dimensional feature map. Reconstructing the above feature values to obtain the one-dimensional feature data can be understood as performing the dimension transformation on the two-dimensional feature map to obtain the one-dimensional feature data, and thus, the above step S202 can be regarded as a step of transforming the two-dimensional feature map into the one-dimensional feature data. The current step is in contrast to the above process S202, the current step intends to reconstruct the one-dimensional feature data into a two-dimensional feature map. Therefore, this step can be regarded as an inverse process of the above step S202.

Particularly, since the two-dimensional feature map to be reconstructed is a two-dimensional image, the number of pixel points of the two-dimensional feature map in the column direction and the number of pixel points of the two-dimensional feature map in the row direction may be determined according to the maximum dimension value on the second dimension and the maximum dimension value on the third dimension, and then may be respectively recorded as a first number and a second number, and then the one-dimensional feature data is split based on the first number and the second number, thus the two-dimensional feature map is reconstructed.

In an implementation, when the one-dimensional feature data is split, second number of feature values may be sequentially read from the one-dimensional feature data as pixel values of one row of pixel points in a to-be-constructed two-dimensional feature map, and the above process is repeated until the feature values are read for the first number of times.

For example, if the one-dimensional feature data contains 600 feature values, the maximum dimension value on the second dimension is 20, and the maximum dimension value on the third dimension is 30, then the first number may be 20 and the second number may be 30, and the two-dimensional feature map to be constructed is the feature map of 20*30. Accordingly, in the process of constructing the two-dimensional feature map, 30 feature values may be read from the one-dimensional feature data each time as the pixel values of one row of pixel points in the two-dimensional feature map, and this process is repeated 20 times, thus completing the construction for the two-dimensional feature map.

In a second step, a three-dimensional feature map containing the two-dimensional feature maps corresponding to the respective dimension values on the first dimension is obtained as the third to-be-processed map.

Particularly, in the three-dimensional image, the two-dimensional feature maps may be arranged according to the dimension values on the first dimension. For example, the two-dimensional feature maps may be arranged in a descending order of the dimensional values.

It can be seen from the above that, in the scheme provided by this embodiment, when the three-dimensional image is constructed, a two-dimensional image is first constructed based on two dimensions, and then the constructed image is integrated according to a third dimension to obtain a three-dimensional image. In this way, the information of the three dimensions is fully considered in the process of constructing the three-dimensional image, thus improving the accuracy of the constructed three-dimensional image.

In an embodiment of the present disclosure, before the performing feature enhancement processing on each feature value in the first feature map based on the third feature map in the above step S205, a non-linear transformation may further be performed on the first feature map.

Since non-linear transformation is capable of increasing the degree of difference between data, the non-linear transformation on the first feature map is capable of increasing the difference between the feature value with strong representativeness and the feature value with weak representativeness in the first feature map. Also, since the feature value with strong representativeness has a great influence on the subsequent feature enhancement processing, the non-linear transformation is performed on the first feature map to increase the degree of difference between the feature values, and accordingly, the feature value with strong representativeness can be accurately determined during the subsequent feature enhancement processing, which is conducive to the feature enhancement processing on the each feature value in the first feature map, thereby improving the accuracy of the text recognition.

Particularly, the non-linear transformation on the first feature map may be implemented through existing non-linear transformation techniques, and thus will not be described in detail herein.

Similarly, before the performing feature enhancement processing on each feature value in the first feature map based on the third feature map in the above step S205, a non-linear transformation may further be performed on the third feature map.

It can be seen from the above that, when the scheme provided by the embodiment of the present disclosure is applied to perform the text recognition, the non-linear transformation on the first feature map is capable of increasing the degree of difference between the feature values in the first feature map, and the non-linear transformation on the third feature map is capable of increasing the degree of difference between the feature values in the third feature map. Performing the non-linear transformation on the first feature map and/or the third feature map is conducive to determining the feature value with strong representativeness during the subsequent feature enhancement processing, which is conducive to the feature enhancement processing, thereby improving the accuracy of the text recognition.

In addition, before the above step S205 is performed, the non-linear transformation may be performed on both the first feature map and the third feature map, or performed on one of the first feature map and the third feature map. Accordingly, it is possible to determine whether the non-linear transformation needs to be performed on the first feature map and the third feature map according to actual requirements, thereby improving the flexibility of the text recognition scheme provided by the embodiment of the present disclosure.

In an embodiment of the present disclosure, after the obtaining a multi-dimensional first feature map of a to-be-recognized image in step S101, the non-linear transformation may further be performed on the first feature map, and then, the above step S102 is performed.

Similar to the disclosed embodiment in which the nonlinear transformation is performed on the first feature map, performing the non-linear transformation on the first feature map is conducive to the feature enhancement processing subsequently performed on the each feature value in the first feature map, thereby improving the accuracy of the text recognition.

In addition, during the text recognition, all of the three nonlinear transformations mentioned in the above embodiment may be applied to the text recognition schemes provided in embodiments of the present disclosure, one or two of the three nonlinear transformations may be applied, or all of the three nonlinear transformations are not used.

During the feature enhancement processing on the each feature value in the first feature map in step S102, in addition to the implementations mentioned in the above embodiments, the feature enhancement processing may further be implemented through the steps S502-S504 in the following embodiment.

In an embodiment of the present disclosure, referring to FIG. 5, a schematic flow diagram of a fifth method for recognizing a text is provided. In this embodiment, the first feature map is a three-dimensional feature map. The above method for recognizing a text includes the following steps S501-S505:

Step 501, obtaining a multi-dimensional first feature map of a to-be-recognized image.

The above step S501 is the same as the foregoing step S101, and thus will not be repeatedly described here.

Step S502, calculating a similarity between pieces of third feature data in the first feature map.

Here, a piece of third feature data includes a feature value corresponding to a dimension value on the first dimension and each combination of a dimension value on the second dimension and a on the first dimension on the third dimension in three dimensions.

One dimension value of the second dimension and one dimension value of the third dimension may constitute a dimension value combination. In this way, the dimension values of the second dimension and the dimension values of the third dimension may constitute a plurality of dimension value combinations.

For each dimension value combination, the dimension values on the second dimension and the dimension values on the third dimension are determined, and the dimension value combination may be combined with each dimension value of the first dimension, to determine the feature value corresponding to the information after the combining in the first feature map. In view of the above, each piece of third feature data includes a plurality of feature values, and the number of the included feature values is equal to the maximum dimension value on the first dimension.

In an implementation, when the similarity is calculated, the third feature data can be converted into a feature vector in a preset vector space. By calculating the similarity between feature vectors, the similarity between pieces of the third feature data corresponding to the feature vectors may be obtained.

Step S503, performing normalization processing on each calculated similarity based on all calculated similarities.

The normalization processing on the similarity may be implemented through a normalization algorithm such as a softmax algorithm, an L1 Normalize algorithm and an L2 Normalize algorithm.

Step S504, performing feature enhancement processing on each feature value in the first feature map based on the similarities after the normalization processing.

Particularly, the similarities after the normalization processing may be used to perform linear weighting on the feature values in the first feature map, thus implementing feature enhancement. Here, the similarities after the normalization processing are used as the weighting coefficients of the linear weighting.

Step S505, performing a text recognition on the to-be-recognized image based on the first feature map after the enhancement processing.

The above step S505 is the same as the foregoing step S103, and thus will not be repeatedly described here.

It can be seen from the above that, when the scheme provided by the embodiment of the present disclosure is applied to perform the text recognition, similarities between pieces of third feature data in the first feature map are calculated, and then the normalization processing is performed on the each calculated similarity using all the calculated similarities. In this way, a similarity after the normalization processing is capable of reflecting the similarity between pieces of third feature data after taking into the global features. Therefore, the similarity after the normalization processing contains global image information. Accordingly, the global image information is taken into consideration when the feature enhancement processing is performed on the each feature value in the first feature map based on the similarities after the normalization processing, such that the first feature map after the feature enhancement has a global receptive field. By performing the text recognition on the to-be-recognized image based on the first feature map having the global receptive field, the accuracy of the text recognition can be improved.

In response to the above method for recognizing a text, an embodiment of the present disclosure further provides an apparatus for recognizing a text.

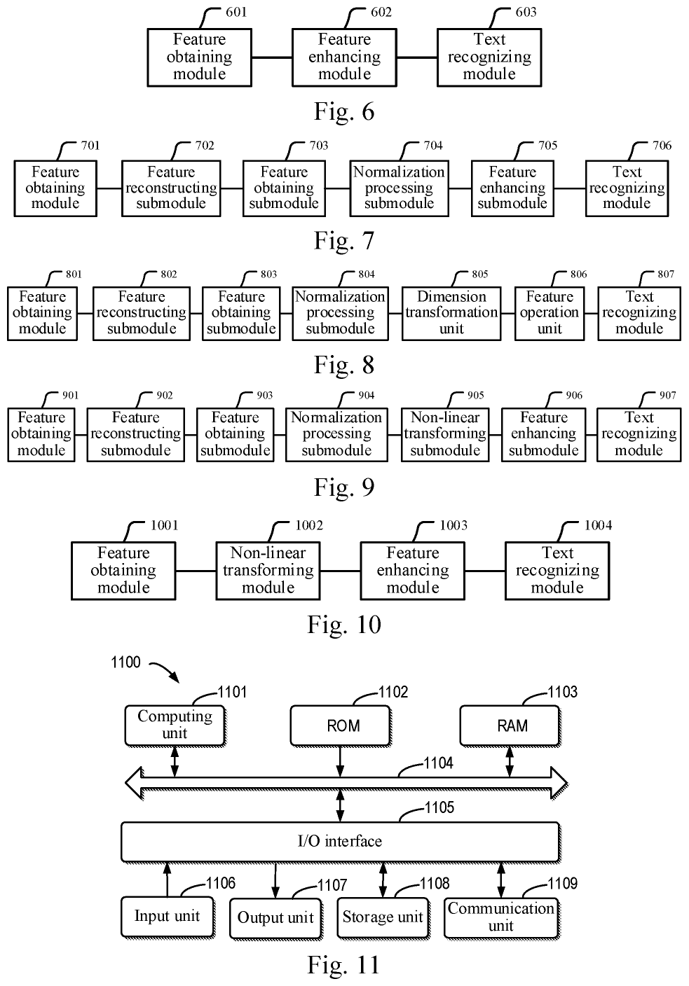

Referring to FIG. 6, FIG. 6 is a schematic structural diagram of a first apparatus for recognizing a text provided in an embodiment of the present disclosure. The apparatus includes:

a feature obtaining module 601, configured to obtain a multi-dimensional first feature map of a to-be-recognized image;

a feature enhancing module 602, configured to perform, based on feature values in the first feature map, feature enhancement processing on each feature value in the first feature map; and

a text recognizing module 603, configured to perform a text recognition on the to-be-recognized image based on the first feature map after the enhancement processing.

It can be seen from the above that, when the scheme provided by the embodiment of the present disclosure is applied to perform the text recognition, the multi-dimensional first feature map of the to-be-recognized image is first obtained, the feature enhancement processing is then performed on the each feature value in the first feature map based on the feature values in the first feature map, and the text recognition is performed based on the first feature map after the enhancement processing, and thus, the text recognition performed on the to-be-recognized image can be implemented.

In addition, during the feature enhancement processing on the each feature value in the first feature map, the processing is performed on the each feature value based on the feature values in the first feature map. Accordingly, the each feature value in the first feature map after the enhancement processing takes the global information of the image into consideration. Therefore, the first feature map after the enhancement processing is capable of representing the global information of the to-be-recognized image, and thus, by performing the text recognition on the to-be-recognized image based on the first feature map after the enhancement processing, the accuracy of the text recognition can be improved.

In an embodiment of the present disclosure, referring to FIG. 7, a schematic structural diagram of a second apparatus for recognizing a text is provided. In this embodiment, the apparatus for recognizing a text includes:

a feature obtaining module 701, configured to obtain a multi-dimensional first feature map of a to-be-recognized image;

a feature reconstructing submodule 702, configured to reconstruct, for each dimension value in dimension values on a first dimension in three dimensions, feature values corresponding to a second dimension and a third dimension under the each dimension value in the first feature map, to obtain a piece of one-dimensional feature data corresponding to the each dimension value;

a feature obtaining submodule 703, configured to obtain a two-dimensional second feature map containing pieces of one-dimensional feature data corresponding to the dimension values on the first dimension;

a normalization processing submodule 704, configured to perform normalization processing on feature values included in each piece of one-dimensional feature data on each dimension of the second feature map, to obtain a third feature map;

a feature enhancing submodule 705, configured to perform feature enhancement processing on each feature value in the first feature map based on the third feature map; and

a text recognizing module 706, configured to perform a text recognition on the to-be-recognized image based on the first feature map after the enhancement processing.

It can be seen from the above that, when the scheme provided by the embodiment of the present disclosure is applied to perform the text recognition, since the normalization processing performed on the feature values included in the one-dimensional feature data needs to be implemented using all the feature values included in the one-dimensional feature data, the each feature value in the one-dimensional feature data after the normalization processing is affected by all the feature values in the one-dimensional feature data. On this basis, the normalization processing is performed on the feature values included in the each piece of one-dimensional feature data on the each dimension in the second feature map, such that the each feature value in the third feature map is affected by all the feature values in the first feature map. Therefore, the third feature map can represent the to-be-recognized image from the perspective of a global feature. In this way, after the feature enhancement processing is performed on the each feature value in the first feature map based on the third feature map, a feature map of which the receptive field is the entire to-be-recognized image can be obtained, which enlarges the receptive field of the feature map for the text recognition, and thus, the accuracy of the text recognition on the to-be-recognized image can be improved.

In an embodiment of the present disclosure, referring to FIG. 8, a schematic structural diagram of a third apparatus for recognizing a text is provided. In this embodiment, the apparatus for recognizing a text includes:

a feature obtaining module 801, configured to obtain a multi-dimensional first feature map of a to-be-recognized image;

a feature reconstructing submodule 802, configured to reconstruct, for each dimension value in dimension values on a first dimension in three dimensions, feature values corresponding to a second dimension and a third dimension under the each dimension value in the first feature map, to obtain a piece of one-dimensional feature data corresponding to the each dimension value;

a feature obtaining submodule 803, configured to obtain a two-dimensional second feature map containing the pieces of one-dimensional feature data corresponding to the dimension values on the first dimension;

a normalization processing submodule 804, configured to perform normalization processing on feature values included in each piece of one-dimensional feature data on each dimension of the second feature map, to obtain a third feature map;

a dimension transformation unit 805, configured to perform a dimension transformation on a first to-be-processed map to obtain a third to-be-processed map having a number of dimensions identical to a number of dimensions of a second to-be-processed map, where the first to-be-processed map refers to the third feature map or the first feature map, and the second to-be-processed map refers to a feature map in the third feature map and the first feature map other than the first to-be-processed map;

a feature operation unit 806, configured to perform a sum operation on feature values at identical positions in the second to-be-processed map and the third to-be-processed map, to obtain a feature map after the sum operation as the first feature map after the enhancement processing; and

a text recognizing module 807, configured to perform a text recognition on the to-be-recognized image based on the first feature map after the enhancement processing.

It can be seen from the above that, when the scheme provided by the embodiment of the present disclosure is applied to perform the text recognition, two feature maps having identical numbers of dimensions are obtained by performing the dimension transformation on one of the first feature map and the third feature map, and then the sum operation is performed on the feature values at identical positions in the two feature maps, and the image after the operation is used as the first feature map after the enhancement processing. The third feature map contains global image information, and thus, by performing the sum operation on the feature values at identical positions in the two feature maps having identical numbers of dimensions, the feature enhancement processing on the first feature map can be accurately implemented, thereby realizing the text recognition.

In an embodiment of the present disclosure, the first to-be-processed map refers to the third feature map, the second to-be-processed map refers to the first feature map.

The dimension transformation unit 805 is configured to: reconstruct, according to the dimension values on the second dimension and the dimension values on the third dimension, the piece of one-dimensional feature data corresponding to each dimension value in the dimension values on the first dimension in the third feature map, to obtain a piece of two-dimensional feature map corresponding to the each dimension value on the first dimension; and

obtain a three-dimensional image containing two-dimensional feature maps corresponding to the dimension values on the first dimension as the third to-be-processed map.

It can be seen from the above that, when the scheme provided by the embodiment of the present disclosure is applied to perform the text recognition, in the process of constructing the three-dimensional image, a two-dimensional image is first constructed based on two dimensions, and then the constructed image is integrated according to a third dimension to obtain a three-dimensional image. In this way, the information of the three dimensions is fully considered in the process of constructing the three-dimensional image, thus improving the accuracy of the constructed three-dimensional image.

In an embodiment of the present disclosure, the normalization processing submodule 804 is configured to:

perform normalization processing on feature values included in each piece of first feature data in the second feature map, wherein the first feature data refers to the piece of one-dimensional feature data corresponding to the each dimension value on the first dimension; and

perform normalization processing on feature values included in each piece of second feature data in the second feature map after the normalization processing, where the each piece of second feature data refers to a piece of one-dimensional feature data corresponding to each dimension value on a combined dimension, and the combined dimension refers to a dimension corresponding to the second and third dimensions in the second feature map.

It can be seen from the above that, in the scheme provided by the embodiment of the present disclosure, when the normalization processing is performed on the feature values included in the each piece of one-dimensional feature data to obtain the third feature map, the normalization processing is first performed on the first feature data corresponding to the each dimension value on the first dimension, and then, on the basis of the normalization processing, the normalization processing is performed on the second feature data corresponding to the each dimension value on the combined dimension. The number of feature values included in the first feature data is equal to the number of dimension values on the combined dimension, and the number of the dimension values on the combined dimension is often greater than the number of dimension values on the first dimension. Therefore, by first performing the normalization processing on the first feature data, more abundant reference data can be provided for the subsequent normalization processing, which is conducive to improving the accuracy of the obtained third feature map.

In an embodiment of the present disclosure, the first dimension is a depth dimension, the second dimension is a width dimension, and the third dimension is a height dimension.

It can be seen from the above that, when the scheme provided by the embodiment of the present disclosure is applied to perform the text recognition, the feature values corresponding to the second and third dimensions under one dimension value of the first dimension in the first feature map can form a two-dimensional feature map according to the height dimension and the width dimension. Accordingly, the reconstruction on the feature values corresponding to the second and third dimensions is equivalent to the reconstruction on the feature values in the two-dimensional feature map. A reconstruction on the feature values in a single two-dimensional feature map can avoid interference caused by other two-dimensional feature maps, thereby facilitating the acquisition of the above one-dimensional feature data.

In an embodiment of the present disclosure, referring to FIG. 9, a schematic structural diagram of a fourth apparatus for recognizing a text is provided. In this embodiment, the apparatus for recognizing a text includes:

a feature obtaining module 901, configured to obtain a multi-dimensional first feature map of a to-be-recognized image;

a feature reconstructing submodule 902, configured to reconstruct, for each dimension value in dimension values on a first dimension in three dimensions, feature values corresponding to a second dimension and a third dimension under the each dimension value in the first feature map, to obtain a piece of one-dimensional feature data corresponding to the each dimension value;

a feature obtaining submodule 903, configured to obtain a two-dimensional second feature map containing pieces of one-dimensional feature data corresponding to the dimension values on the first dimension;

a normalization processing submodule 904, configured to perform normalization processing on feature values included in each piece of one-dimensional feature data on each dimension of the second feature map, to obtain a third feature map;

a non-linear transforming submodule 905, configured to perform a non-linear transformation on the first feature map and/or the third feature map, before feature enhancement processing is performed on each feature value in the first feature map based on the third feature map;

a feature enhancing submodule 906, configured to perform the feature enhancement processing on the each feature value in the first feature map based on the third feature map; and

a text recognizing module 907, configured to perform a text recognition on the to-be-recognized image based on the first feature map after the enhancement processing.

It can be seen from the above that, when the scheme provided by the embodiment of the present disclosure is applied to perform the text recognition, the non-linear transformation on the first feature map is capable of increasing the degree of difference between the feature values in the first feature map, and the non-linear transformation on the third feature map is capable of increasing the degree of difference between the feature values in the third feature map. Performing the non-linear transformation on the first feature map and/or the third feature map is conducive to determining the feature value with strong representativeness during the subsequent feature enhancement processing, which is conducive to the feature enhancement processing, thereby improving the accuracy of the text recognition.

In an embodiment of the present disclosure, referring to FIG. 10, a schematic structural diagram of a fifth apparatus for recognizing a text is provided. In this embodiment, the apparatus for recognizing a text includes:

a feature obtaining module 1001, configured to obtain a multi-dimensional first feature map of a to-be-recognized image;

a non-linear transforming module 1002, configured to perform a non-linear transformation on the first feature map, after the multi-dimensional first feature map of the to-be-recognized image is obtained;

a feature enhancing module 1003, configured to perform, for each feature value in the first feature map, feature enhancement processing on the feature value based on the feature values in the first feature map; and

a text recognizing module 1004, configured to perform a text recognition on the to-be-recognized image based on the first feature map after the enhancement processing.

It can be seen from the above that, when the scheme provided by the embodiment of the present disclosure is applied to perform the text recognition, performing the non-linear transformation on the first feature map is conducive to the subsequent feature enhancement processing performed on the each feature value in the first feature map, thereby improving the accuracy of the text recognition.

In an embodiment of the present disclosure, the first feature map is a three-dimensional feature map. The feature enhancing module 1003 is configured to:

calculate a similarity between pieces of third feature data in the first feature map, wherein a piece of third feature data comprises a feature value on the first dimension corresponding to each combination of a dimension value on the second dimension and a dimension value on the third dimension in the three dimensions;

perform normalization processing on each calculated similarity based on all calculated similarities; and

perform the feature enhancement processing on the each feature value in the first feature map based on the similarity after the normalization processing.

It can be seen from the above that, when the scheme provided by the embodiment of the present disclosure is applied to perform the text recognition, similarities between pieces of third feature data in the first feature map are calculated, and then the normalization processing is performed on the each calculated similarity using all the calculated similarities. In this way, a similarity after the normalization processing is capable of reflecting the similarity between pieces of third feature data after taking into the global features. Therefore, the similarity after the normalization processing contains global image information. Accordingly, the global image information is taken into consideration when the feature enhancement processing is performed on the each feature value in the first feature map based on the similarities after the normalization processing, such that the first feature map after the feature enhancement has a global receptive field. By performing the text recognition on the to-be-recognized image based on the first feature map having the global receptive field, the accuracy of the text recognition can be improved.

According to an embodiment of the present disclosure, an electronic device, a readable storage medium, and a computer program product are provided.

An embodiment of the present disclosure provides an electronic device, including:

at least one processor, and

a storage device, in communication with the at least one processor.

Here, the storage device stores instructions executable by the at least one processor, and the instructions, when executed by the at least one processor, enable the at least one processor to perform any method for recognizing a text in the above method embodiments.

An embodiment of the present disclosure provides a non-transitory computer readable storage medium storing a computer instruction. Here, the computer instruction, when executed by a computer, causes the computer to perform any method for recognizing a text in the above method embodiments.

An embodiment of the present disclosure provides a computer program product, including a computer program. The computer program, when executed by a processor, cause the processor to implement any method for recognizing a text in the above method embodiments.

FIG. 11 is a schematic block diagram of an exemplary electronic device 1100 that may be used to implement embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may alternatively represent various forms of mobile apparatuses such as personal digital processing, a cellular telephone, a smart phone, a wearable device and other similar computing apparatuses. The parts shown herein, their connections and relationships, and their functions are only as examples, and not intended to limit implementations of the present disclosure as described and/or claimed herein.

As shown in FIG. 11, the computer system 1100 includes a computing unit 1101, which may execute various appropriate actions and processes in accordance with a program stored in a read-only memory (ROM) 1102 or a program loaded into a random access memory (RAM) 1103 from a storage portion 1108. The RAM 1103 also stores various programs and data required by operations of the system 1100. The computing unit 1101, the ROM 1102 and the RAM 1103 are connected to each other through a bus 1104. An input/output (I/O) interface 1105 is also connected to the bus 1104.

The following components are connected to the I/O interface 1105: an input unit 1106 including such as a keyboard, a mouse etc.; an output unit 1107 comprising such as displays of various types, a speaker etc.; a storage unit 1108 including a hard disk, an optical disk, and the like; and a communication unit 1109 comprising, such as a network interface card, a modem, and a wireless communication transceiver. The communication unit 1109 allows the device 1100 to exchange information/data with other devices through a computer network such as the Internet and/or various telecommunication networks.

The computing unit 1101 may be a variety of general purpose and/or dedicated processing components having processing and computing capabilities. Some examples of the computing unit 1101 include, but are not limited to, a central processing unit (CPU), a graphics processing unit (GPU), various dedicated artificial intelligence (AI) computing chips, various computing units that run machine learning model algorithms, a digital signal processor (DSP), and any suitable processor, controller, microcontroller, and the like. The calculation unit 1101 performs various methods and processes described above, such as a text recognition method. For example, in some embodiments, the text recognition method may be implemented as a computer software program that is tangibly contained in a machine-readable medium, such as a storage unit 1108. In some embodiments, part or all of the computer program may be loaded and/or installed on the device 1100 via the ROM 1102 and/or the communication unit 1109. When a computer program is loaded into the RAM 1103 and executed by the computing unit 1101, one or more steps of the text recognition method described above may be performed. Alternatively, in other embodiments, the computing unit 1101 may be configured to perform the text recognition method by any other suitable means (e.g., by means of firmware).

Various embodiments of the systems and technologies described above herein may be implemented in digital electronic circuit systems, integrated circuit systems, field programmable gate arrays (FPGA), application specific integrated circuits (ASIC), application specific standard products (ASSP), systems on chip (SOC), complex programmable logic devices (CPLD), computer hardware, firmware, software, and/or combinations thereof. These various implementations may include: being implemented in one or more computer programs, the one or more computer programs may be executed and/or interpreted on a programmable system including at least one programmable processor, which may be a dedicated or general-purpose programmable processor; receiving data and instructions from a storage system, at least one input device, and at least one output device; and transmitting data and instructions to the storage system, the at least one input device, and the at least one output device.

The program code for implementing the method described in embodiments of the present disclosure may be written in any combination of one or more programming languages. These program codes may be provided to a processor or controller of a general-purpose computer, a special-purpose computer, or other programmable data processing apparatus so that the program codes, when executed by the processor or controller, cause the functions/operations specified in the flowchart and/or block diagram to be implemented. The program code may be executed completely on the machine, partially on the machine, partially on the machine and partially on the remote machine as a stand-alone software package, or completely on the remote machine or server.

In the context of the present disclosure, the machine-readable medium may be a tangible medium that may contain or store programs for use by or in combination with an instruction execution system, apparatus, or device. The machine-readable medium may be a machine-readable signal medium or a machine-readable storage medium. Machine readable media may include, but are not limited to, electronic, magnetic, optical, electromagnetic, infrared, or semiconductor systems, devices, or devices, or any suitable combination of the above. More specific examples of machine-readable storage media may include one or more wire based electrical connections, portable computer disks, hard disks, random access memory (RAM), read only memory (ROM), erasable programmable read only memory (EPROM or flash memory), optical fibers, portable compact disk read only memory (CD-ROM), optical storage devices, magnetic storage devices, or any suitable combination of the above.

To provide interaction with a user, the systems and technologies described herein may be implemented on a computer, the computer has: a display apparatus for displaying information to the user, such as a Cathode Ray Tube (CRT) or an liquid crystal display (LCD) monitor; and a keyboard and pointing apparatus, such as a mouse or a trackball, and a user may use the keyboard and the pointing apparatus to provide input to the computer. Other types of apparatuses may also be used to provide interaction with the user. For example, the feedback provided to the user may be any form of sensory feedback, such as visual feedback, auditory feedback, or tactile feedback; and any form (including acoustic input, voice input, or tactile input) may be used to receive input from the user.

The systems and technologies described herein may be implemented in a computing system that includes backend components, e.g., as a data server, or in a computing system that includes middleware components, e.g., an application server, or in a computing system including front-end components, e.g., a user computer having a graphical user interface or a web browser through which a user may interact with embodiments of the systems and technologies described herein, or in a computing system including any combination of such backend components, middleware components, or front-end components. The components of the system may be interconnected by any form or medium of digital data communication, e.g., a communication network. Examples of communication networks include: Local Area Network (LAN), Wide Area Network (WAN), the Internet, and block chain networks.

The computer system may include a client and a server. The client and server are generally far from each other and usually interact through a communication network. The relationship between the client and the server is generated by computer programs that run on the corresponding computer and having a client-server relationship with each other. The server can be a cloud server, a server of a distributed system, or a server combined with a blockchain.

It should be understood that the various forms of processes shown above may be used to reorder, add, or delete steps. For example, the steps described in embodiments of the present disclosure may be performed in parallel, sequentially, or in different orders. As long as the desired results of the technical solution disclosed in the present disclosure can be achieved, no limitation is made herein.

The above specific embodiments do not constitute limitation on the scope of the present disclosure. Those skilled in the art should understand that various modifications, combinations, sub-combinations and substitutions may be made according to design requirements and other factors. Any modification, equivalent replacement and improvement made within the principle of the present disclosure shall be included in the protection scope of the present disclosure.

What is claimed is:

1. A method for recognizing a text, comprising:
obtaining a multi-dimensional first feature map of a to-be-recognized image;
performing, based on feature values in the first feature map, feature enhancement processing on each feature value in the first feature map; and
performing a text recognition on the to-be-recognized image based on the first feature map after the enhancement processing.

2. The method according to claim 1, wherein the first feature map is a three-dimensional feature map, and
performing, based on the feature values in the first feature map, feature enhancement processing on the each feature value in the first feature map comprises:
for each dimension value in dimension values on a first dimension in three dimensions, reconstructing feature values corresponding to a second dimension and a third dimension under the each dimension value in the first feature map, to obtain a piece of one-dimensional feature data corresponding to the each dimension value;
obtaining a two-dimensional second feature map containing pieces of one-dimensional feature data corresponding to the dimension values on the first dimension;
performing normalization processing on feature values included in each piece of one-dimensional feature data on each dimension of the second feature map, to obtain a third feature map; and
performing the feature enhancement processing on the each feature value in the first feature map based on the third feature map.

3. The method according to claim 2, wherein performing the feature enhancement processing on the each feature value in the first feature map based on the third feature map comprises:
performing a dimension transformation on a first to-be-processed map to obtain a third to-be-processed map having a number of dimensions identical to a number of dimensions of a second to-be-processed map, wherein the first to-be-processed map refers to the third feature map or the first feature map, and the second to-be-processed map refers to a feature map in the third feature map and the first feature map other than the first to-be-processed map; and
performing a sum operation on feature values at identical positions in the second to-be-processed map and the third to-be-processed map, to obtain a feature map after the sum operation as the first feature map after the enhancement processing.

4. The method according to claim 3, wherein the first to-be-processed map refers to the third feature map, the second to-be-processed map refers to the first feature map, and
performing the dimension transformation on the first to-be-processed map to obtain the third to-be-processed map having the number of dimensions identical to the number of dimensions of the second to-be-processed map comprises:
reconstructing, according to the dimension values on the second dimension and the dimension values on the third dimension, the piece of one-dimensional feature data corresponding to the each dimension value in the dimension values on the first dimension in the third feature map, to obtain a two-dimensional feature map corresponding to the each dimension value on the first dimension; and
obtaining a three-dimensional image containing two-dimensional feature maps corresponding to the dimension values on the first dimension as the third to-be-processed map.

5. The method according to claim 2, wherein performing normalization processing on the feature values included in the each piece of one-dimensional feature data on each dimension of the second feature map to obtain the third feature map comprises:
performing normalization processing on feature values included in each piece of first feature data in the second feature map, wherein the first feature data refers to the piece of one-dimensional feature data corresponding to the each dimension value on the first dimension; and
performing normalization processing on feature values included in each piece of second feature data in the second feature map after the normalization processing, wherein the each piece of second feature data refers to a piece of one-dimensional feature data corresponding to each dimension value on a combined dimension, and the combined dimension refers to a dimension corresponding to the second and third dimensions in the second feature map.

6. The method according to claim 2, wherein the first dimension is a depth dimension, the second dimension is a width dimension, and the third dimension is a height dimension.

7. The method according to claim 2, wherein, before performing the feature enhancement processing on the each feature value in the first feature map based on the third feature map, the method further comprises:
performing a non-linear transformation on the first feature map and/or the third feature map.

8. The method according to claim 1, wherein, after obtaining the multi-dimensional first feature map of the to-be-recognized image, the method further comprises:
performing a non-linear transformation on the first feature map.

9. The method according to claim 1, wherein the first feature map is the three-dimensional feature map, and
performing, based on the feature values in the first feature map, feature enhancement processing on the each feature value in the first feature map comprises:
calculating a similarity between pieces of third feature data in the first feature map, wherein a piece of third feature data comprises a feature value on the first dimension corresponding to each combination of a dimension value on the second dimension and a dimension value on the third dimension in the three dimensions;
performing normalization processing on each calculated similarity based on all calculated similarities; and
performing the feature enhancement processing on the each feature value in the first feature map based on similarities after the normalization processing.

10. An electronic device, comprising:
at least one processor; and
a storage device, in communication with the at least one processor,
wherein the storage device stores instructions which, when executed by the at least one processor, enable the at least one processor to perform operations, the operations comprising:
obtaining a multi-dimensional first feature map of a to-be-recognized image;
performing, based on feature values in the first feature map, feature enhancement processing on each feature value in the first feature map; and
performing a text recognition on the to-be-recognized image based on the first feature map after the enhancement processing.

11. The electronic device according to claim 10, wherein the first feature map is a three-dimensional feature map, and
performing, based on the feature values in the first feature map, feature enhancement processing on the each feature value in the first feature map comprises:
for each dimension value in dimension values on a first dimension in three dimensions, reconstructing feature values corresponding to a second dimension and a third dimension under the each dimension value in the first feature map, to obtain a piece of one-dimensional feature data corresponding to the each dimension value;
obtaining a two-dimensional second feature map containing pieces of one-dimensional feature data corresponding to the dimension values on the first dimension;
performing normalization processing on feature values included in each piece of one-dimensional feature data on each dimension of the second feature map, to obtain a third feature map; and
performing the feature enhancement processing on the each feature value in the first feature map based on the third feature map.

12. The electronic device according to claim 11, wherein performing the feature enhancement processing on the each feature value in the first feature map based on the third feature map comprises:
performing a dimension transformation on a first to-be-processed map to obtain a third to-be-processed map having a number of dimensions identical to a number of dimensions of a second to-be-processed map, wherein the first to-be-processed map refers to the third feature map or the first feature map, and the second to-be-processed map refers to a feature map in the third feature map and the first feature map other than the first to-be-processed map; and
performing a sum operation on feature values at identical positions in the second to-be-processed map and the third to-be-processed map, to obtain a feature map after the sum operation as the first feature map after the enhancement processing.

13. The electronic device according to claim 12, wherein the first to-be-processed map refers to the third feature map, the second to-be-processed map refers to the first feature map, and
performing the dimension transformation on the first to-be-processed map to obtain the third to-be-processed map having the number of dimensions identical to the number of dimensions of the second to-be-processed map comprises:
reconstructing, according to the dimension values on the second dimension and the dimension values on the third dimension, the piece of one-dimensional feature data corresponding to the each dimension value in the dimension values on the first dimension in the third feature map, to obtain a two-dimensional feature map corresponding to the each dimension value on the first dimension; and
obtaining a three-dimensional image containing two-dimensional feature maps corresponding to the dimension values on the first dimension as the third to-be-processed map.

14. The electronic device according to claim 11, wherein performing normalization processing on the feature values included in the each piece of one-dimensional feature data on each dimension of the second feature map to obtain the third feature map comprises:
performing normalization processing on feature values included in each piece of first feature data in the second feature map, wherein the first feature data refers to the piece of one-dimensional feature data corresponding to the each dimension value on the first dimension; and
performing normalization processing on feature values included in each piece of second feature data in the second feature map after the normalization processing, wherein the each piece of second feature data refers to a piece of one-dimensional feature data corresponding to each dimension value on a combined dimension, and the combined dimension refers to a dimension corresponding to the second and third dimensions in the second feature map.

15. The electronic device according to claim 11, wherein the first dimension is a depth dimension, the second dimension is a width dimension, and the third dimension is a height dimension.

16. The electronic device according to claim 11, wherein, before performing the feature enhancement processing on the each feature value in the first feature map based on the third feature map, the operations further comprise:
performing a non-linear transformation on the first feature map and/or the third feature map.

17. The electronic device according to claim 10, wherein, after obtaining the multi-dimensional first feature map of the to-be-recognized image, the operations further comprise:
performing a non-linear transformation on the first feature map.

18. The electronic device according to claim 10, wherein the first feature map is the three-dimensional feature map, and
performing, based on the feature values in the first feature map, feature enhancement processing on the each feature value in the first feature map comprises:
calculating a similarity between pieces of third feature data in the first feature map, wherein a piece of third feature data comprises a feature value on the first dimension corresponding to each combination of a dimension value on the second dimension and a dimension value on the third dimension in the three dimensions;
performing normalization processing on each calculated similarity based on all calculated similarities; and
performing the feature enhancement processing on the each feature value in the first feature map based on similarities after the normalization processing.

19. A non-transitory computer readable storage medium, storing computer instructions which, when executed by a computer, cause the computer to perform operations, the operations comprising:
obtaining a multi-dimensional first feature map of a to-be-recognized image;
performing, based on feature values in the first feature map, feature enhancement processing on each feature value in the first feature map; and
performing a text recognition on the to-be-recognized image based on the first feature map after the enhancement processing.

20. The computer readable storage medium according to claim 19, wherein the first feature map is a three-dimensional feature map, and
performing, based on the feature values in the first feature map, feature enhancement processing on the each feature value in the first feature map comprises:
for each dimension value in dimension values on a first dimension in three dimensions, reconstructing feature values corresponding to a second dimension and a third dimension under the each dimension value in the first feature map, to obtain a piece of one-dimensional feature data corresponding to the each dimension value;
obtaining a two-dimensional second feature map containing pieces of one-dimensional feature data corresponding to the dimension values on the first dimension;
performing normalization processing on feature values included in each piece of one-dimensional feature data on each dimension of the second feature map, to obtain a third feature map; and
performing the feature enhancement processing on the each feature value in the first feature map based on the third feature map.
